(19) United States
(12) Patent Application Publication
(10) Pub. No.: US 2005/0010800 A1
(43) Pub. Date: Jan. 13, 2005

(54) [PORTABLE COMPUTER SECURITY OPERATING METHOD]

(76) Inventor: Rong-Jung Lee, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,917

(22) Filed: Nov. 6, 2003

(30) Foreign Application Priority Data
Jul. 10, 2003 (TW) 92118831

(51) Int. Cl. H04L 9/00

(52) U.S. Cl. 713/200

(57) ABSTRACT

The embodiment of the present invention provides an operating method of a portable computer security mechanism. The operating method first providing a key signal to an embedded controller (EC). Upon receiving the key signal, a security check and a security action is taken place accordingly by the EC. The security action including preventing an input from a keyboard, preventing an input from a mouse, preventing the portable computer from being turned on, preventing a BIOS data from being changed, and etc.

### CROSS REFERENCE TO RELATED APPLICATIONS

This application claims the priority benefit of Taiwan application serial no. 92118831, filed Jul. 10, 2003.

### BACKGROUND OF INVENTION

1. Field of the Invention

The present invention pertains to a portable computer in general, and more particularly to an operating method of a portable computer security mechanism.

2. Description of the Related Art

Presently, a portable computer (for instance, a laptop computer) is getting popular. In a near future, it is possible for everybody to own a portable computer. However, as a data transferring technology gets mature, with a portable data-transferring device, data can be carried and transferred from one computer to the other computer conveniently. In between, data can also be stolen easily. Nowadays, a portable computer is commonly not equipped with a security system. It is possible for a top-secret data in a portable computer to get stolen in few minutes. Therefore, a portable computer security system is in a great need to protect a user data from being stolen.

### SUMMARY OF INVENTION

Accordingly, the preferred embodiment of the present invention provides an operating method of a portable computer security system. The preferred embodiment of the present invention exploits a function of an embedded controller (EC) and a switch to monitor a keyboard, a mouse interface, or an input of a power supply switch to secure the portable computer from being hacked.

The operating method of a portable computer security system of the invention equips a portable computer with an EC, and the EC contains a security mechanism. In the operating method, a key is first provided. The key provides a signal sending to the EC to indicate whether the portable computer is locked. Next, if the EC detects that the portable computer is locked, the EC turns on the security mechanism. Then, the security mechanism determines whether the portable computer is hacked or is attempted to be hacked by a hacker; the security mechanism responds with a corresponding security action such as a security notice, an alarm, or a lock-up of the portable computer.

In the preferred embodiment of the present invention, a security action includes locking up a power supply, locking up a keyboard input, locking up a mouse input, informing a security signal to a basic input/output system (BIOS) of the portable computer to take a further security action.

In the preferred embodiment of the present invention, the key is a physical key unit or a functional key unit in the portable computer, or is a key unit or key function of an external device.

In the preferred embodiment of the present invention, a follow-up procedure is started after the security mechanism is turned on. The follow-up procedure includes turning the portable computer off, turning a monitor of the portable computer off, or executing a specific security program.

As a summary to the above description, the preferred embodiment of the present invention utilizes an external device, an internal device unit, or an internal function of the portable computer to be a security key. Then, via a signal produced by a security key related circuit, the EC learns whether the portable computer is locked. Upon the EC recognizing that the portable computer is locked, the EC turns on the security mechanism. Further, the security mechanism gives out an alarm, a warning message, or a security action when a hacking action is detected. Therefore, the preferred embodiment of the present invention equips a portable computer with a security mechanism to secure data in the portable computer.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 demonstrates a portable computer of the preferred embodiment of the present invention.

FIG. 2 depicts a flow-chart diagram of the operating method of the portable computer security mechanism of the preferred embodiment of the present invention.

### DETAILED DESCRIPTION

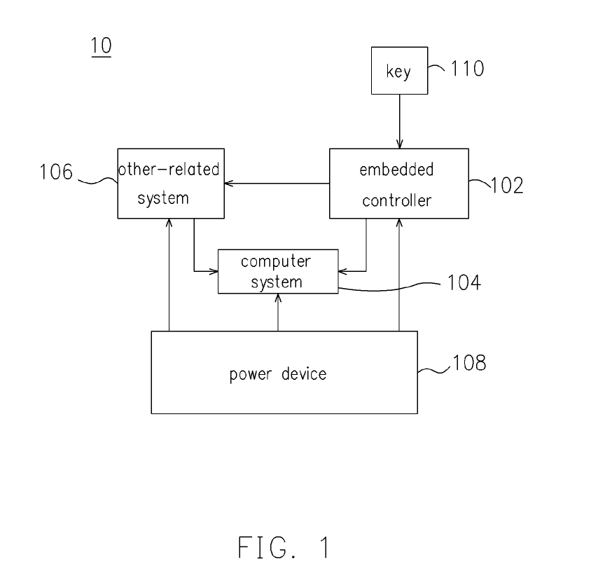

Referring to FIG. 1, a portable computer 10 of the preferred embodiment of the present invention is depicted. The portable computer 10 comprises an EC 102, a computer system 104, an other-related system 106, power unit 108, and a key 110. The EC 102 is used to control an operation of the computer system 104 and the other-related system 106, and is equipped with a security mechanism. The key 110 accompanying with a key circuit provides a signal to the EC 102 to indicate whether the portable computer 10 is locked. The key 110 is, for instance, an internal key unit or an internal key function of the portable computer 10. For example, the key 110 can be a special key on a keyboard; when the key is pressed down, the EC 102 learns that the portable computer 10 is locked. Or, the key 110 can be an unit or a function of an external device. For instance, the key 110 can be a button on a infrared remote control device; when the button is pressed down, an infrared signal is transmitted to the portable computer 10, and the EC activates the security mechanism accordingly. It is clear to those skilled in the art that the key 110 is any kind of apparatus that allows the EC 102 to learn whether the portable computer 10 is locked.

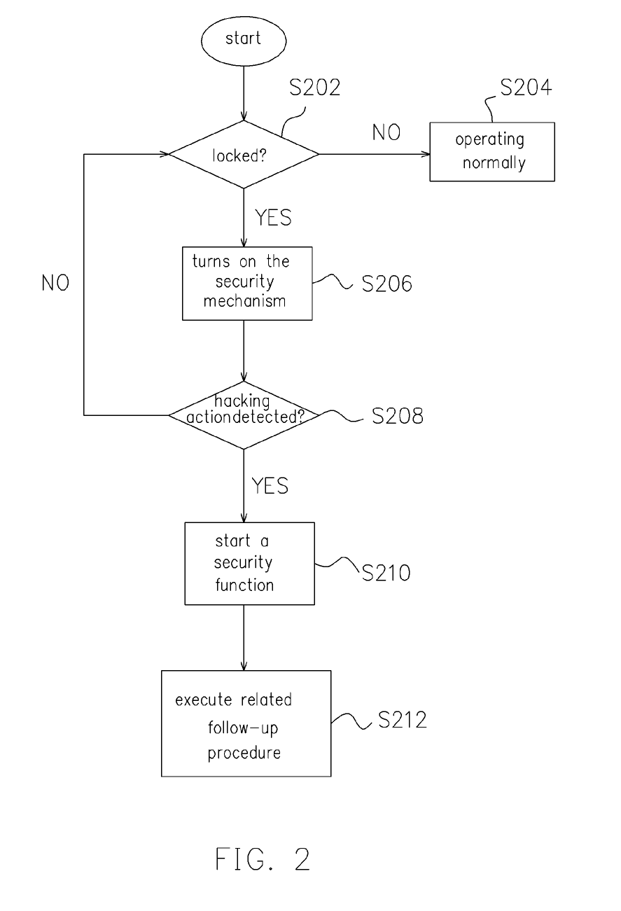

Referring to FIG. 2, a flow-chart diagram of the operating method of the portable computer security mechanism of the preferred embodiment of the present invention is depicted. In the operating method, fist a function of the key 110 is assigned to an external device, or an internal device or function of the portable computer 10. Then, via the key 110 related circuit in the portable computer 10, a signal is generated to inform the EC 102 whether the portable computer is locked as demonstrated in step S202. If the EC 102 learns that the portable computer is not locked, the EC 102 allows the portable computer to function normally as demonstrated in step S204. On the other hand, if the EC 102 learns that the portable computer is locked, the EC 102 turns on the security mechanism accordingly as demonstrated in step S206. The security mechanism provides security functions including preventing the portable computer 10 to turn on from a hacker, preventing a keyboard input from a hacker, preventing a mouse input from a hacker, and providing a security signal to BIOS to secure a BIOS data from being changed. Next, the EC 102 determines whether the portable computer 10 is hacked or is being hacked by a hacker as demonstrated in step S208. The EC 102 goes back to step S202, if the portable computer 10 is not hacked or is not being hacked by a hacker. However, if the EC 102 determines that the portable computer 10 is hacked or is being hacked, the EC 102 turns on a security function as demonstrated in step S210. Further, a follow-up security procedure is taken place as demonstrated in step S212. The follow-up security procedure includes turning off the portable computer, shutting down a monitor of the portable computer, or executing a specific security program. Taking one step further, a related security action includes an attack or a self-destroy action.

In the preferred embodiment of the present invention, the key 110 is coupled to a terminal of the EC 102. It is clear to those skilled in the art that a signal from the key 110 related circuit sending to the EC 102 can be a binary signal, however, the signal is not confined to a binary signal.

As a summary to the above description, the preferred embodiment of the present invention utilizes an external device, or an internal device or an internal function of the portable computer 10 to be a security key. Then, via a signal produced by a security key related circuit, the EC 102 learns whether the portable computer 10 is locked. Upon the EC 102 recognizing that the portable computer 10 is locked, the EC 102 turns on the security mechanism. Further, the security mechanism gives out an alarm, a warning message, or a security action when a hacking action is detected. Therefore, the preferred embodiment of the present invention equips a portable computer with a security mechanism to secure data in the portable computer 10.

It will be apparent to those skilled in the art that various modifications and variations can be made to the structure or to the methods of the preferred embodiment of the present invention without departing from the scope or spirit of the invention. In view of the foregoing, it is intended that the present invention cover modifications and variations of this invention provided they fall within the scope of the following claims and their equivalents.

1. An operating method of a portable computer security mechanism in which the portable computer is equipped with an embedded controller (EC), and the EC is equipped with a security mechanism, which comprises:
providing a key that provides a key signal to allow the EC to learn whether the portable computer is locked;
turning on the security mechanism while the EC receives the key signal indicating that the portable computer is locked;
determining whether a hacking action is take place; and
activating a security action in responding to the hacking action.

2. The operating method of claim 1, wherein the security mechanism prevents the portable computer from being turned on.

3. The operating method of claim 1, wherein the security mechanism prevents an input from a keyboard.

4. The operating method of claim 1, wherein the security mechanism prevents an input from a mouse.

5. The operating method of claim 1, wherein the security mechanism prevents a basic input/output system (BIOS) data from being changed.

6. The operating method of claim 1, wherein the key is an internal device or an internal function of the portable computer.

7. The operating method of claim 1, wherein the key is an external device or an external function of the portable computer.

8. The operating method of claim 1, wherein the key signal is a binary signal.

9. The operating method of claim 1, wherein a related follow-up procedure of a security function takes place when a hacking action is detected by the security mechanism.

10. The operating method of claim 9, wherein the related follow-up procedure turns off the portable computer.

11. The operating method of claim 9, wherein the related follow-up procedure turns off a monitor device of the portable computer.

12. The operating method of claim 9, wherein the related follow-up procedure executes a security program.
